(19) United States
(12) Patent Application Publication
(10) Pub. No.: US 2006/0083006 A1
(43) Pub. Date: Apr. 20, 2006

(54) Reflector lamp

(76) Inventor: Gunther Van De Poel, Kortenaken (BE)

Correspondence Address: BROOKS KUSHMAN P.C., 1000 TOWN CENTER, TWENTY-SECOND FLOOR, SOUTHFIELD, MI, 48075, US

(21) Appl. No.: 11/226,851

(22) Filed: Sep. 14, 2005

(30) Foreign Application Priority Data
Sep. 14, 2004 (EP) 04 021 799.4

(51) Int. Cl. F21V 7/00

(52) U.S. Cl. 362/346

(57) ABSTRACT

In a reflector lamp (1, 100) with a discharge lamp (5, 50) arranged on the reflector's longitudinal axis (4, 40) within the concave reflector (3, 30) having a base (2, 20), said discharge lamp having a fill comprising or forming salts which, in the burning discharge lamp (5, 50) in a position of its longitudinal axis deviating from an upright position, especially in essentially horizontal position of same, at least partially condense from the vapor phase into the liquid phase as a condensate at the colder, lower side of the discharge space (7, 70), and having a reflector surface (8, 80) comprising two differently curved surface areas (F1, F2), whereby a first surface area (F1) backwardly arranged towards the base (2) and a second surface area (F2) joining thereto and forwardly arranged towards the reflector opening (9) are provided, which areas are formed by rotary surfaces which possess a conic section line as a generatrix each, the reflector (3, 30) has two or more surface areas (F1, F2; F10, F20, F30) selected from the said rotary surfaces, and the respective curvatures or vaults or in the case of conical surfaces the opening angles of these surface areas (F1, F2; F10, F20, F30), respectively, are formed so, and the light rendering centre (5′, 50′) of the discharge lamp (5, 50) is arranged on the reflector's longitudinal axis (4, 40) and in relation to the first surface area (F1, F10) such, that the light of the discharge lamp (5, 50) passing through these salts can be distributed over the whole illuminated surface (19, 190) as evenly as possible.

The invention concerns a reflector lamp with a discharge lamp arranged on the reflector's longitudinal axis within the concave reflector having a base, said discharge lamp having a fill comprising or forming salts which, in the burning discharge lamp in a position of its longitudinal axis deviating from an upright position, especially in essentially horizontal position of same, at least partially condense from the vapor phase into the liquid phase as a condensate at the colder, lower side of the discharge space, and having a reflector surface comprising two differently curved surface areas, whereby a first surface area backwardly arranged towards the socket and a second surface area joining thereto and forwardly arranged towards the reflector opening are provided, which areas are formed by rotary surfaces which possess a conic section line as a generatrix each.

In a reflector lamp of this structure known from EP 1 076 203 A2 the first surface area is a paraboloid, an ellipsoid or a spheroid and the second surface area is a paraboloid provided with longitudinal ribs, which surface areas in common serve in minimizing of the hot spots in the center of radiation, whereby the configuration of these surface areas is made such that the light rendered by the lamp in toto is radiated in a light conus of 0 to 5 degrees from the reflector's longitudinal axis, hence, practically with parallel radiation.

Will now a discharge lamp of the said kind be used as a lamp forming the light source, and particularly in a position in which the position of the longitudinal axis of the discharge lamp is slanted relative to the horizontal between zero and 45 degrees, especially is horizontal, then the light rays, passing through the said condensate, which is colored yellow and absorbs blue light, and impinging downwardly onto the ellipsoidal surface area and being reflected therefrom essentially parallel to the lamp's longitudinal axis, because of their yellow coloration would form a yellow stain on the illuminated surface in the lower region of same. However, such a demixing of the colors of the projected light is not desired, desired is a homogenous color distribution of the light on the illuminated surface.

The object underlying the invention is, therefore, seen in creating a lamp of the kind depicted in which, under avoiding the demixing of colors as described, a distribution of the color portions within the light as uniform as possible, or a good color mixture, respectively, is provided.

This object in accordance with the invention is met in that the reflector has two or more surface areas selected from the said rotary surfaces, and that the respective curvatures or vaults or in the case of conical surfaces the opening angles of these surface areas, respectively, are formed so, and the light rendering center of the discharge lamp is arranged on the reflector's longitudinal axis and in relation to the first surface area such, that the light of the discharge lamp passing through these salts can be distributed over the whole illuminated surface as evenly as possible.

As the said rotary surfaces mentioned paraboloids, ellipsoids, frustrated cone surfaces and spherical surfaces are usable in accordance with the invention.

Thereby each of the different surface areas of a reflector shall have different curvatures or vaults or opening angles, respectively, such that each of the surface areas exposing a certain depth catches some of the yellow light from the condensed salts of the discharge lamp and reflects same onto a region of the illuminated surface other than the other surface areas do.

In this manner the yellow light can be distributed more uniformly over the illuminated surface. Thereby the arrangement is usefully such that from the apex of the reflector in the direction towards the reflector opening each normal dropped onto a tangent at a point of the respective curvature is closer to the vertical than the preceding normal onto the tangent at a point lying closer to the apex.

By this it can be achieved that the light rays originating from the yellow salts are reflected proceedingly more upwardly towards the center of the illuminated surface and beyond such center.

In a first embodiment of the invention two surface areas are provided and the first surface area is formed as a paraboloid and the second surface area as an ellipsoid.

In accordance with a second embodiment three surface areas are provided and the first surface area is formed as a paraboloid, the second surface area as a frustrated cone surface and the third surface area also as a frustrated cone surface.

Four or more surface areas were also possible. It can be said generally that the distribution of the yellow light rays stemming from the said condensed salts can be adjusted the more uniform or even, respectively, the more surface areas of the said kind are present in a reflector according to the invention. It should be understood, however, that the manufacture of a reflector having more than three surface areas becomes particularly costly.

In order to get an especially good distribution or no demixing, respectively, of the yellow light rays even with two or three surface areas only, it has proved to hold good to provide the first surface area with spherical facets in a wafer structure.

Beyond that it can be advantageous in a special case to provide also the second surface area with flat spiral or cylindrical, respectively, facets, whereby in this case flat spiral or cylindrical facets have proved to be sufficient which do not scatter as strongly as the spherical facets do.

In a preferred embodiment of a reflector in accordance with the invention having two surface areas the light rendering center of the discharge lamp is situated between the focus of the first surface area and the base of the reflector, whereas the focus (not shown) of the second surface area is displaced to the side of the light rendering center which is directed away from the base. In such an arrangement the path of the rays has proved to be particularly favorable.

In an actually manufactured example of a reflector lamp in accordance with the invention, having a diameter of 50 mm and two surface areas, the depth of the reflector is about 28 mm, the depth of its first surface area starting from its apex is about 8.5 mm and the depth of its bordering second surface area is about 19.5 mm. The light rendering center of the discharge lamp is about 4.3 mm distant from the said apex (13) and thereby located about in the center of the first surface area, and the focus of the first surface area lies about 5, 8 mm distant from this apex.

In another embodiment of a reflector lamp in accordance with the invention having three surface areas, also the first surface area can be a paraboloid, the second surface area a frustrated cone surface and the third surface area an ellipsoid.

Also the use of a paraboloid as the first surface area, an ellipsoid as the second surface area and a frustrated cone surface as the third surface area forms an additional embodiment.

In a manufactured test example of a reflector lamp having a diameter of 111 mm and three surface areas, whereby the first surface area is a paraboloid, the second surface area is a frustrated cone surface and the third surface area is also a frustrated cone surface, the depth of the reflector is about 36.2 mm, the depth of its first surface area starting from its apex is about 15 mm, the depth of its bordering second surface area is between about 5 mm and about 8 mm, and the depth of its third surface area bordering to the latter is between about 16.2 mm and about 13.2 mm, and the light rendering center of the discharge lamp is located about 17 mm distant from the said apex in the focus of the first surface area.

In the embodiments each having three surface areas the distribution of the yellow light rays can be further improved by having provided the first and the second surface areas with spherical facets in a wafer structure and the third surface area with spirally flat or cylindrical facets.

The invention and its advantageous further developments are more fully elucidated in the following by means of embodiments in the attached drawings.

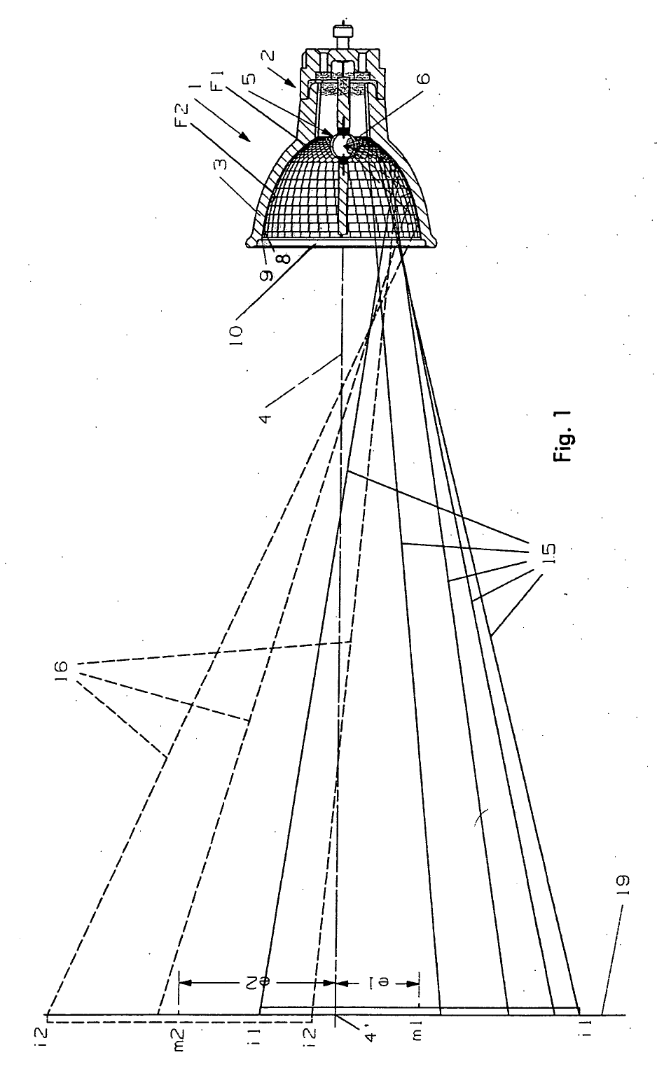

It is shown in FIG. 1 a first embodiment of a reflector lamp in accordance with the invention with two surface areas and the appertaining path of the rays, whereby the first surface area is formed as a paraboloid and the second surface area as an ellipsoid, in a longitudinal section;

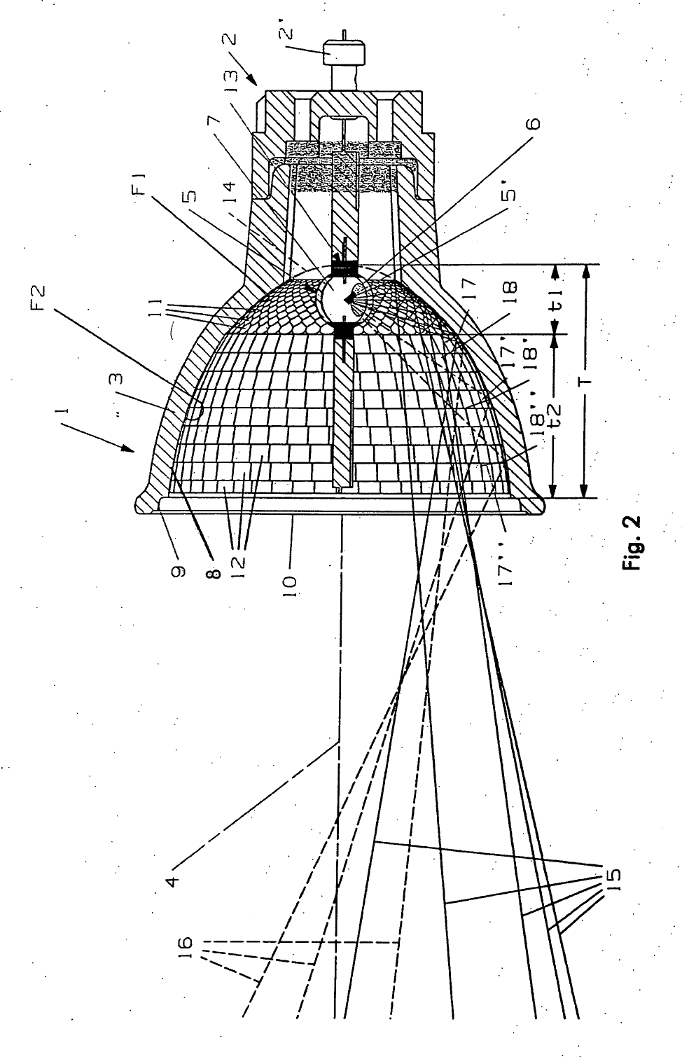

FIG. 2 is the reflector lamp of FIG. 1 in an enlarged scale;

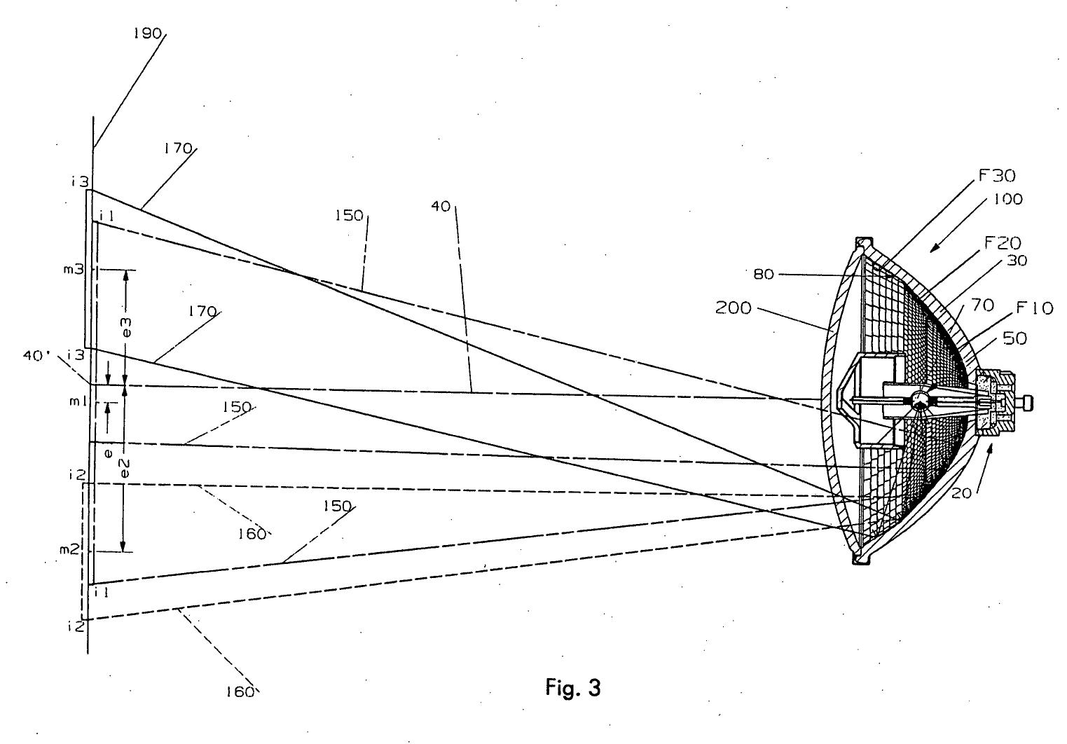

FIG. 3 is a second embodiment of a reflector lamp in accordance with the invention with three surface areas and the appertaining path of the rays, whereby the first surface area is formed as a paraboloid, the second surface area as a frustrated cone surface and the third surface area also as a frustrated cone surface, in a longitudinal section;

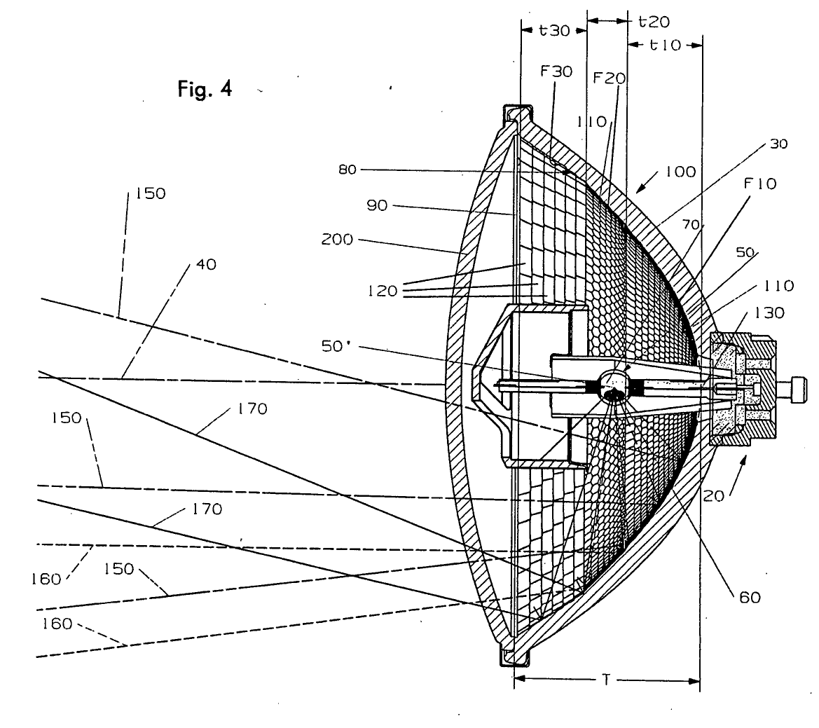

FIG. 4 is the reflector lamp of FIG. 3 on an enlarged scale;

In FIGS. 1 and 2 are a first embodiment of the reflector lamp 1 is depicted. It has in the reflector 3 having a base 2 a discharge lamp 5 arranged on the reflector's longitudinal axis with a fill possessing or forming salts which in the burning discharge lamp 5, particularly in the horizontal position of its longitudinal axis as depicted which here is congruent with the reflector's longitudinal axis 4, at least partially sublimate from the vapor phase into the solid state of aggregation as a condensate 6 at the colder, lower side of the discharge space 7.

The discharge lamp 5 in the embodiment shown is a halide metal vapor discharge lamp with electrical leads which are connected to terminals 2′ at base 2, but respective problems with the condensates depending on their respective fills can occur also with other lamps, as the case may be also with electrodeless discharge lamps.

The reflector 3 has a concave reflector surface with two differently curved or vaulted, respectively, surface areas F1 and F2, whereby a rear first surface area F1 arranged towards the base 2 and a second surface area F2 joining thereto and arranged towards the reflector opening 9, covered by a lens 10 or the like, are provided which are formed by rotary surfaces possessing a conic section line as a generatrix each.

In the embodiment shown two surface areas are provided, the first surface area F1 formed as a paraboloid and the second surface area F2 as an ellipsoid. Thereby preferredly the first surface area F1 is provided with spherical facets 11 in a wafer structure and the second surface area F2 is provided with flat spiral or cylindrical facets 12, respectively.

The light rendering center 5′ of the discharge lamp 5 which is assumed to be in the middle of the discharge space 7, is located here between the focus (not shown) of the first surface area F1 and the base 2 of the reflector 3, whereas the focus (not shown) of the second surface area F2 is displaced to the side of the light rendering center 5′ which is directed away from the base 2, i. e. towards the lens 10.

In a manufactured reflector lamp 1 in accordance with this embodiment having a diameter of 50 mm, the depth T of the reflector 3 is about 28 mm, the depth t1 of its first surface area F1 starting from its apex 13 is about 8.5 mm and the depth t2 of its bordering or joining, respectively, second surface area F2 is about 19.5 mm. The light rendering center 5′ of the discharge lamp 5 is about 4.3 mm distant from the said apex 13 and thereby located about in the center of the first surface area F1. The focus of the first surface area F1 lies about 5.8 mm distant from this apex 13.

The apex 13 of the parabolic surface or paraboloid, respectively, of the first surface area F1 and the part 14 of the first surface area F1 shown grated and immediately surrounding said apex is cut off by the base 2, so-to-say, all the more because it is covered to a great extent by the discharge chamber 7 of the discharge lamp 5 and could not add an essential contribution to light reflexion anyway.

In FIG. 1 the path of the rays is depicted which pass through the condensate 6 and are colored thereby, colored yellow as a rule. The light rays reflected from the first surface area F1 are shown with full lines having the reference numeral 15, the light rays 16 reflected from the second surface area F2 are depicted with broken lines.

Following the law of reflexion the angle of incidence of a light ray impinging on the reflector's surface is equal to the angle of reflexion thereof, independent from whether those angles are measured as against a tangent at the point of incidence on the reflector surface or as against the normal dropped onto the tangent at the point of incidence. This is valid in general and naturally for all embodiments of the invention.

In FIG. 2 three of such normals 17, 17′ and 17″ on points of incidence 18, 18′ and 18″ at the elliptical second surface area F2 are shown. From these points of incidence 18, 18′, 18″ the three depicted light rays 16 start. For the light rays 15 departing from the parabolic first surface area F1 naturally the same is valid.

In FIG. 1 the surface illuminated by the rays 15 and 16 is shown, i. e. the illumination surface 19. The reflector's longitudinal axis 4 impinges at 4′, that is at the illumination center, onto the illuminated surface 19.

The yellow light rays 15 starting from the first surface area F1 thereby illuminate a surface which in the side view shown is hinted by the end points i1, i1 and a center point m1. This surface covers the lower region of the illuminated surface 19 and extends upwardly beyond the center point 4′ of the illuminated surface. Its center point m1 is displaced with regard to the center point 4′ of the illuminated surface 19 downwardly by the distance e1.

The light rays 16 starting from the second surface area F2 thereby illuminate a surface which in the side view shown is hinted by the end points i2, i2 and by a center point m2. This surface covers the upper region of the illuminated surface 19 and reaches almost to the center point 4′ of the illuminated surface 19. Its center point m2 is displaced with regard to the center point 4′ upwardly by the distance e2.

As to be seen, in the region between i1 and i2 there is a minor coverage of the rays 15 and 16. In toto there results a scattering of the yellow light rays 15 and 16 over the entire illumination surface 19 and by this a good distribution of same and mixture with the other light from discharge lamp 5. By this a demixing and thereby a yellow stain particularly in the lower region of the illuminated surface 19 is avoided.

In this 50 mm reflective lamp 1 the depth t1 of the first surface area F1 is dependent essentially on the length of the discharge chamber of discharge lamp 5 and the position of discharge lamp 5 or its light rendering center 5′, respectively. Namely, if the depth t1 and by this the length of F1 would become longer and longer, then the portion of the yellow light of the condensate reflected by the first surface area F1 would become larger and larger and would be reflected downwardly. Only a small portion of the yellow light, only a fraction thereof, would impinge onto the second surface area F2 and be reflected upwardly. The result in combination would be a concentrated yellow light in the lower region of the illuminated surface 19, what is to be avoided.

In FIGS. 3 and 4 a second embodiment of the reflector lamp 100 is depicted. In the same manner as the first embodiment in its concave reflector 30 having a base 20 it possesses a discharge lamp 50 arranged on the reflector's longitudinal axis 40 and having a fill which comprises or forms salts which in the burning lamp 50, particularly in the horizontal position of its longitudinal axis shown, which axis also here is congruent with the reflector's longitudinal axis 40, sublime at least partially from the gas phase into the solid state of aggregation as condensate 60 at the colder lower side of the discharge space 70.

In this second embodiment the reflector 30 has a concave reflector surface 80 with three differently curved or vaulted, respectively, surface areas F10, F20 and F30, whereby a rear first surface area F10 appertaining to the base 20, a medium surface area F20 joining thereto, and a third surface area F30 are provided. The third surface area F30 borders to the reflector opening 90 and is covered by a lens 200 or the like. All the surface areas F10, F20 and F30 are formed by rotary surfaces each possessing a conic section line as generatrix.

In the preferred embodiment shown there are formed the first surface area F10 as a paraboloid, the second surface area F20 as a frustrated cone surface F20 and the third surface area F30 also a frustrated cone surface.

Further, the light rendering center 50′ of discharge lamp 50 is located in the focus of the first surface area F10. The second and third surface areas F20 and F30 in the form of frustrated cone surfaces naturally do not have focuses.

In a manufactured reflector lamp 20 in accordance with this embodiment having a diameter of 111 mm, the depth T of the reflector is about 36.2 mm, the depth t10 of its first surface area F10 starting from its apex 130 is about 15 mm, the depth t20 of its adjoining second surface area F20 is between about 5 mm and about 8 mm, and the depth t30 of the third surface area F30 bordering to the latter surface is between about 16.2 mm and about 13.2 mm. The light rendering center 50′ of the discharge lamp 50 is located about 17 mm distant from the said apex 130, in the focus of the first surface area F10.

In this case the focus of the first surface area F10 is located very close to the lens 200, i. e. in a larger distance from apex 130. The length or depth, respectively, t10 and by this the first surface area F10 ends at the beginning of the discharge space of discharge lamp 50 and the length or depth, respectively, t20 and by this the second surface area F20 begins there and extends a little bit beyond the end of the discharge space of the discharge lamp 50 which is maximally 8 mm long. In this manner the second surface area F20 has about the same function as the first surface area F1 in the reflector lamp having 50 mm according to the first embodiment.

Preferably are provided the first and the second surface areas F10 and F20 with spherical facets in a wafer structure and the third surface area F30 with flat spiral or cylindrical, respectively, facets.

In FIG. 3 the surface illuminated by the light rays 150 and 160 is shown, the illuminated surface 190. The reflector's longitudinal axis 40 meets at 40′, which is the illumination center, the illuminated surface 190.

The yellow light rays 150 starting from the first surface area F10 are shown interrupted and illuminate a surface which in the side view depicted in FIG. 3, as in the first embodiment already, is hinted by end points i1 and i1 and the center point ml which lies by the distance e1 and thereby only little beneath the center 40 of the illuminated surface 190. This surface covers almost the whole area of the illumination surface 190.

The yellow light rays 160 starting from the second surface area F20 thereby illuminate a surface which in the side view shown again is hinted by the end points i2, i2 and a center point m2. This surface covers only the lower region of the illuminated surface 190, its center point m2 lies beneath the center point 40′ by a distance e2.

The yellow light rays 170 starting from the third surface area F30 illuminate a surface which in the side view shown is hinted by end points e3, e3 and a center point m3. This surface lies above center point 40 by the distance e3.

As to be seen, the surface i1, i1 covers the larger portion of the two surfaces i2, i2 and i3, i3. In toto there results a scattering of the yellow light rays 150, 160 and 170 which reaches over the whole illuminated surface 190 and by this a very good distribution of such rays and mixing with the other light from the discharge lamp 50. Demixing and thereby a yellow stain particularly in the lower region of the illuminated surface 190 are avoided.

It should be emphasized that within the frame of the invention other arrangements formed from rotary surfaces of conic section lines are possible. E.g. in the second embodiment as described the first surface area can be a paraboloid, the second surface area a frustrated cone surface and the third surface area an ellipsoid (not shown). Also attention is expressly drawn here to the possibility to form in a manner not shown the first surface area as a paraboloid, the second surface area as an ellipsoid and the third surface area as frustrated cone surface.

1. Reflector lamp (1, 100) with a discharge lamp (5, 50) arranged on the reflector's longitudinal axis (4, 40) within the concave reflector (3, 30) having a base (2, 20), said discharge lamp having a fill comprising or forming salts which, in the burning discharge lamp (5, 50) in a position of its longitudinal axis deviating from an upright position, especially in essentially horizontal position of same, at least partially condense from the vapor phase into the liquid phase as a condensate at the colder, lower side of the discharge space (7, 70), and having a reflector surface (8, 80) comprising two differently curved surface areas (F1, F2), whereby a first surface area (F1) backwardly arranged towards the base (2) and a second surface area (F2) joining thereto and forwardly arranged towards the reflector opening (9) are provided, which areas are formed by rotary surfaces which possess a conic section line as a generatrix each,
characterized in
that the reflector (3, 30) has two or more surface areas (F1, F2; respectively, F10, F20, F30) selected from the said rotary surfaces, and that the respective curvatures or vaults or in the case of conical surfaces the opening angles of these surface areas (F1, F2; F10, F20, F30), respectively, are formed so, and the light rendering center (5′, 50′) of the discharge lamp (5, 50) is arranged on the reflector's longitudinal axis (4, 40) and in relation to the first surface area (F1; F10) such, that the light of the discharge lamp (5, 50) passing through these salts can be distributed over the whole illuminated surface (19; 190) as evenly as possible.

2. Reflector lamp (1) according to claim 1,
characterized in
that two surface areas (F1, F2) are provided and the first surface area (F1) is formed as a paraboloid and the second surface area (F2) as an ellipsoid.

3. Reflector lamp (1) according to claim 1,
characterized in
that three surface areas (F10, F20, F30) are provided and the first surface area (F10) is formed as a paraboloid, the second surface area (F20) as a frustrated cone surface and the third surface area (F30) also as a frustrated cone surface.

4. Reflector lamp (1) according to claim 1, 2 or 3,
characterized in
that the first surface area (F1) is provided with spherical facets (11) in a wafer structure.

5. Reflector lamp according to claim 1, 2, 3 or 4,
characterized in
that the second surface area (F2) is provided with flat spiral or cylindrical facets (12), respectively.

6. Reflector lamp (1) according to claim 1, 2, 4 or 5,
characterized in
that the light rendering center (5′) of the discharge lamp (5) is located between the focus of the first surface area (F1) and the base (2) of the reflector (3), whereas the focus (not shown) of the second surface area (F2) is displaced to the side of the light rendering center (5′) which is directed away from the base (2).

7. Reflector lamp (100) according to one of claims 1, 3, 4 or 5,
characterized in
that the light rendering center (50′) of the discharge lamp (50) is located in the focus of the first surface area (F10), whereas the focuses, as far as present, of the additional surface area or surface areas (F20, F30), respectively, is or are, respectively, displaced to the side of the light rendering center (50′) which is directed away from the base (20).

8. Reflector lamp (1) according to claim 1, 2, 4, 5 or 6,
characterized in
that the depth (T) of the 50 mm-reflector (3) is about 28 mm, the depth (t1) of its first surface area (F1) starting from its apex (13) is about 8.5 mm and the depth (t2) of its bordering second surface area (F2) is about 19.5 mm, that the light rendering center of the discharge lamp (5) is about 4.3 mm distant from the said apex (13) and thereby located about in the center of the first surface area (F1), and that the focus of the first surface area (F1) lies about 5.8 mm distant from this apex (13).

9. Reflector lamp according to claim 1, 3, 4, 5 or 7,
characterized in
that the first surface area is a paraboloid, the second surface area is a frustrated cone surface and the third surface area is an ellipsoid.

10. Reflector lamp according to claim 1, 3, 4, 5 or 8,
characterized in
that the first surface area is a paraboloid, the second surface area is an ellipsoid and the third surface area is a frustrated cone surface.

11. Reflector lamp (100) according to claim 1, 3, 6, 7, 9 or 10,
characterized in
that the depth (T) of the 111 mm-reflector (30) is about 36.2 mm, the depth (t10) of its first surface area (F10) starting from its apex (130) is about 15 mm, the depth (t20) of its bordering second surface area (F20) is between about 5 mm and about 8 mm, and the depth (t30) of its third surface area (F30) bordering to the latter is between about 16.2 mm and about 13.2 mm, and that the light rendering center of the discharge lamp (50) is located about 17 mm distant from the said apex (130) in the focus of the first surface area (F10).

12. Reflector lamp (100) according to claim 3, 4, 5, 9, 10 or 11,
characterized in
that the first and the second surface areas (F10, F20) are provided with spherical facets (110) in wafer structure and the third surface area (F30) is provided with flat spiral or cylindrical facets (120), respectively.

13. Reflector lamp according to claim 1, 2, 4, 5, 6 or 8,
characterized in
that the depth (t1) of the first surface area (F1) corresponds to the maximum length of the discharge space plus 25% of same.

14. Reflector lamp according to claim 8,
characterized in
that the light rendering center of the discharge lamp (5) is arranged in a distance of about. 4.3 mm from the apex (13) of the first surface area (F1), that the length of the discharge chamber of the discharge lamp (5) is about. 8 mm, and that the maximum depth (t1) of the first surface area (F1) is about. 8.3 mm.

15. Reflector lamp according to claim 1, 3, 4, 5, 7, 9, 10, 11 or 12,
characterized in
that the focus of the first surface area (F10) is located very close to the lens (200), that the depth (t10) of the first surface area (F10) ends at the beginning of the discharge space of the discharge lamp (50), and that the depth (t20) of the second surface area (F20) starts at this beginning and extends maximally to the end of the discharge space of the discharge lamp (50) plus 25% of same, whereby the discharge space is maximally 8 mm long.
